(19) United States
(12) Patent Application Publication
(10) Pub. No.: US 2009/0285584 A1
(43) Pub. Date: Nov. 19, 2009

(54) UNREPEATERED OPTICAL SEGMENT FOR USE WITH REPEATERED SERIES OF OPTICAL SEGMENTS

(75) Inventors: Herve Albert Pierre Fevrier, Plano, TX (US); Phillippe Andre Perrier, Plano, TX (US)

Correspondence Address: Workman Nydegger;1000 Eagle Gate Tower, 60 East South Temple, Salt Lake City, UT, 84111, US

(73) Assignee: Xtera Communication Inc., Allen, TX (US)

(21) Appl. No.: 12/121,757

(22) Filed: May 15, 2008

(51) Int. Cl. H04B 10/00

(52) U.S. Cl. 398/173

(57) ABSTRACT

An optical communications network that includes an unrepeatered optical segment that optically couples a remote terminal to a branching unit optically coupled within a series of repeatered optical segments. The unrepeatered optical segment may be quite long through the use of Raman amplification and/or remote optical pumped amplifiers thereby extending the reach of the unrepeatered optical segment. The branching unit or one of the repeaters may optionally be configured, perhaps remotely, to perform Raman amplification.

### BACKGROUND

Fiber-optic communication networks serve a key demand of the information age by providing high-speed data between network nodes. Fiber optic communication networks include an aggregation of interconnected fiber-optic links. Simply stated, a fiber-optic link involves an optical signal source that emits information in the form of light into an optical fiber. Due to principles of internal reflection, the optical signal propagates through the optical fiber until it is eventually received into an optical signal receiver. If the fiber-optic link is bi-directional, information may be optically communicated in reverse typically using a separate optical fiber.

Fiber-optic links are used in a wide variety of applications, each requiring different lengths of fiber-optic links. For instance, relatively short fiber-optic links may be used to communicate information between a computer and its proximate peripherals, or between local video source (such as a DVD or DVR) and a television. On the opposite extreme, however, fiber-optic links may extend hundreds or even thousands of kilometers when the information is to be communicated between two network nodes.

Long-haul and ultra-long-haul optics refers to the transmission of light signals over long fiber-optic links on the order of hundreds or thousands of kilometers. Transmission of optic signals over such long distances presents enormous technical challenges. Significant time and resources may be required for any improvement in the art of long-haul and ultra-long-haul optical communication. Each improvement can represent a significant advance since such improvements often lead to the more widespread availability of communication throughout the globe. Thus, such advances may potentially accelerate humankind's ability to collaborate, learn, do business, and the like, regardless of where an individual resides on the globe.

One of the many challenges that developers of long-haul optic links face involves fiber loss. When an optical signal is transmitted into an optical fiber, that optical signal has a certain power. In Dense Wavelength Division Multiplexing (DWDM), that optical power is split between several channels, each channel corresponding to optical signals at or around a certain corresponding wavelength. However, as the optical signal travels through the optical fiber, the power of the optical signal decreases in an approximately logarithmically linear fashion. Even the best optical fibers have some attenuation per unit length of fiber. These challenges cannot always be addressed by simply increasing the optical power of the input optical signal, since saturation effects cause the electrical power required to transmit at a particular optical power to increase dramatically as the optical power approaches a saturation point.

Accordingly, in repeatered systems, repeaters are often used at certain intervals in a length of optical fiber to thereby amplify the optical signal. The repeaters are typically placed at a sufficiently close distance that the optical signal power is still a significant level above the optical noise. If the optical signal were permitted to approach to close or decline below the optical noise, the optical signal as would become difficult or impossible to retrieve. Repeaters require electrical power in order to perform the optical amplification. Accordingly, if power is otherwise unavailable to the repeater, the power may be supplied via an electrical conductor in the optical cable itself A typical distance between repeaters can be, for example, 50 to 100 kilometers.

In some cases, if the distance from the transmission terminal to the receiver terminal is not too long, the optical link may not use repeaters at all. Such unrepeatered systems might use a combination of Remote Optically Pumped Amplifier (ROPA) and forward and backward Raman pumping in order to extend the distance for such unrepeatered links to perhaps 300 to 500 kilometers or more in length. However, such unrepeatered fiber-optic links are not presently feasible for certain longer lengths.

### BRIEF SUMMARY

Embodiments described herein related to various aspects of an optical communications network. The optical communications network includes a series connection of repeatered optical segments interconnecting two remote terminals. Optically, the series connection may include a branching unit that is optically coupled within the series connection and serves an unrepeatered optical segment that optically couples the branching unit to yet another terminal. The unrepeatered optical segment may be quite long through the use of Raman amplifiers, rare-earth doped fiber amplifiers (such as Erbium Doped Fiber Amplifiers (EDFAs)) and/or remote optical pumped amplifiers thereby extending the reach of the unrepeatered optical segment. Accordingly, existing repeatered systems may be extended to allow optical communication to and from previously unserved or underserved remote locations without having to incur the expense of supplying, powering and maintaining additional repeaters. Various aspects described herein also relate to the installation of such an unrepeatered optical segment into an existing series connection of repeatered optical segments.

Other aspects described herein involve the use of such a network to actually perform optical communication over part of the series connection of repeatered optical segments, and through the unrepeatered optical segment. Optionally, the branching unit and/or one or more of the repeaters may be configured as to perform forward and/or backward Raman amplification. This configuration may even occur remotely with appropriate control signals being provided perhaps through in-band or out-of-band optical communication, or perhaps via electrical communication through modulated signals on an electrical power line provided in or with the optical cable. Accordingly, the branching unit or repeater may be reconfigured without retrieving or otherwise accessing the branching unit or repeater.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 schematically illustrates an optical communications network that includes a repeatered series of optical segments, and a branched unrepeatered optical segment;

FIG. 2 illustrates a typical power-distance profile showing example optical powers as an optical signal propagates in the eastern direction through a portion of the repeatered series of optical segments and through the unrepeatered optical segment in the case where there is just one Remote Optical Pumped Amplifier (ROPA) operating to amplify East-bound optical signals using residual backward Raman pump power;

FIG. 3 illustrates a typical power-distance profile showing example optical powers as an optical signal propagates in the western direction through the unrepeatered optical segment and through a portion of the repeatered series of optical as segments in the case where there are no ROPAs amplifying west-bound optical signals;

FIG. 4 illustrates a flowchart of a method for installing the unrepeatered optical segment into the optical communications network;

FIG. 5 schematically illustrates a configurable Raman device that may be part of or used as the branching unit or a repeater enclosure in FIG. 1;

FIG. 6 illustrates a flowchart of a method for configuring the optical communication network; and

FIG. 7 illustrates a flowchart of a method for optically communicating in an optical communications network through a portion of a repeatered series of optical segments, and through an unrepeatered optical segment.

### DETAILED DESCRIPTION

In accordance with embodiments described herein, an optical communications network includes an unrepeatered optical segment that optically couples a remote terminal to a unrepeatered optical segment, optionally via a branching unit. The unrepeatered optical segment may be quite long through the use of Raman amplifiers, rare-earth doped fiber amplifiers (such as Erbium Doped Fiber Amplifiers (EDFAs)) and/or remote optical pumped amplifiers thereby extending the reach of the unrepeatered optical segment. The branching unit or one of the repeaters may optionally be configured, perhaps remotely, to perform Raman amplification.

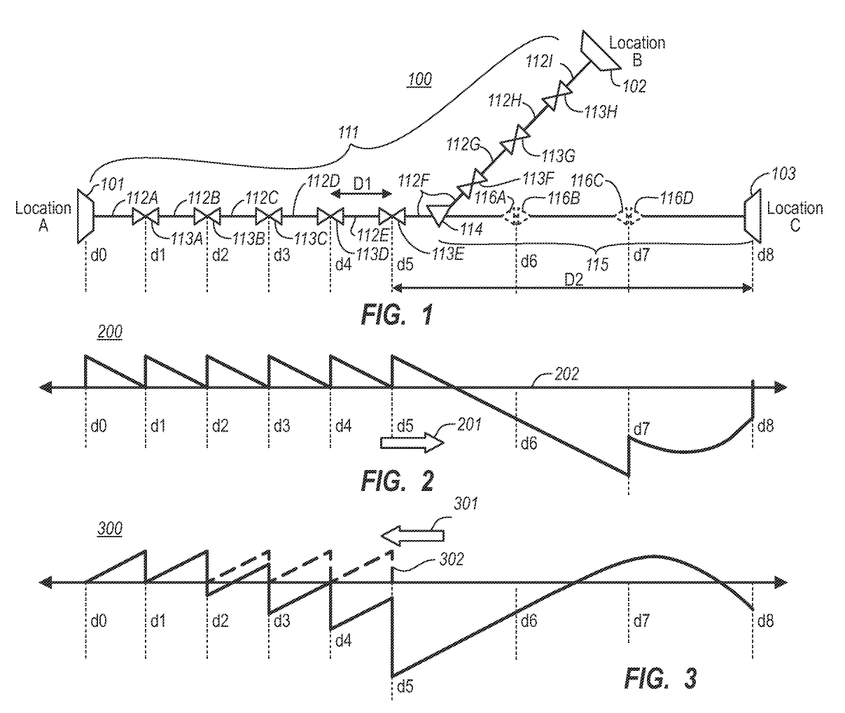

FIG. 1 schematically illustrates an example optical communications network 100 in which the principles described herein may be employed. The optical communications network 100 includes a series connection 111 of repeatered optical segments 112 interconnected via repeaters 113. The series connection 111 optically connects two remote terminals; namely terminal 101 (at location A) and terminal 102 (at location B). In one embodiment, the series connection 111 of repeatered optical segments 112 may be preexisting and may have provided optical communications between the terminals 101 and 102 for some time.

The series connection 111 is illustrated as including nine optical segments 112A through 112I interconnected by eight repeaters 113A through 113H. However, this series connection 111 is simply just an example used for purposes of illustration as only. The principles described herein may be applied to any series connection of n+1 optical segments interconnected by n optical repeaters (where “n” is any positive integer). The optical segments 112A through 112H may be collectively referred to herein as “optical segments 112” or “each optical segment 112”. The repeaters 113A through 113H may be collectively referred to herein as “repeaters 113” or “each repeater 113”.

Each optical segment 112 includes one or more optical fibers. To facilitate bi-directional communication, each optical segment may include at least one optical fiber pair, one fiber for each direction of communication. However, there is no limit to the number of optical fibers or optical fiber pairs that may be within an optical segment. To facilitate communication over long distances between repeaters, the optical fibers are typically single mode optical fibers. The optical fibers are typically contained within an optical cable that provides environmental protection for the optical fibers.

The repeaters serve to perform optical amplification of the optical signal. This might be performed using any mechanism now known or whether not yet developed. As an example, optical amplifications may be performed using Erbium-Doped Fiber Amplifiers (EDFAs) or other rare-earth doped optical fiber amplifiers, Raman amplifiers, and/or Semiconductor Optical Amplifiers (SOAs). However, the improvements described herein are not limited to these types of amplification. Repeater amplification does, however, require electrical power to be supplied to the amplifier. Accordingly, the optical cable might contain an electrical conductor to allow power to be supplied from the terminals 101 and/or 102 to each repeater 113.

The series connection 111 is illustrated as having a particular physical layout. Specifically, the series connection is illustrated as proceeding straight from the terminal 101 (at location A) to a branching unit 114, then turning diagonally upwards and to the right to thereby proceed straight to the terminal 102 (at location B). However, such a physical layout is arbitrary and need not relate to the actual physical layout of the optical segments. For instance, for submarine applications, optical segments may wind around physical barriers on the ocean floor and may have some amount of slack that causes other turns. The precise physical layout is not critical. It is the optical path length of the optical segment that is of primary concern.

Typically, however, the optical path length between repeaters is approximately the same. The distance between repeaters will depend on the total terminal-to-terminal optical path distance, the data rate, the quality of the optical fiber, the loss-characteristics of the fiber, and so forth. However, a typical optical path length between repeaters for high-quality single mode fiber might be about 50 kilometers, and in practice may range from 30 kilometers or less to 90 kilometers or more. That said, the principles described herein are not limited to any particular optical path distances between repeaters, nor are they limited to repeater systems in which the optical path distances are the same from one repeatered segment to the next.

Each optical segment is bounded by a repeater at one end and either a terminal or another repeater at the other end. The terminals 101 and 102 serve as sources and destinations of optical signals. For instance, terminal 101 may transmit an optical signal into the series 111 where the optical signal repeatedly goes through iterations of attenuations in the optical segment followed by amplification in the repeater, until the optical signal is received by terminal 102. For purposes of convention used within this application, optical signals transmitted from the terminal 101 will be said to be in the “eastern” direction, whereas optical signals received by the terminal 101 will be said to be in the “western” direction. That said, the use of the terms “eastern” and “western” does not imply any actually geographical relation of components in FIG. 1, nor to any actual physical direction of optical signals. They are simply terms of art used to allow for easy reference with respect to a written representation of an optical communications network. For instance, terminals 102 and 103 may, in geographical reality, actually be located westward of the terminal 101. In the western direction, terminal 102 may transmit an optical signal into the series 111 where the optical signal repeatedly goes through iterations of attenuations and amplifications until the optical signal is received by terminal 101.

The optical communications network 100 also optionally includes a branching unit 114, and an unrepeatered optical segment 115 that optically couples the branching unit 114 to a remote terminal 103 at location C. The branching unit 114 operates to channel some of the forward optical signals from the terminal 101 to the terminal 103, and some of the eastern optical signals from the terminal 101 to the terminal 102. In the western direction, optical signals from the terminals 102 and 103 are provided through the branching unit 114 to the terminal 101. While only one branching unit is shown in FIG. 1, other branching units may exist in the series connection 111 that allow for possible other branching points and segments that are not illustrated.

In one embodiment, the optical signals are Wavelength Division Multiplexed (WDM) and potentially Dense Wavelength Division Multiplexed (DWDM) in which information is communicated over each of multiple distinct optical channels, each optical channel corresponding to light at a particular frequency. In that case, the branching unit 114 may perform branching and recombination of the as optical signals by performing band demultiplexing and multiplexing, respectively.

Alternatively or in addition, the branching unit 114 may channel some of the optical fibers through one branch, and some through the other branch. For instance, if there are two optical fiber pairs between the terminal 101 and the branching unit 114, there might be one optical fiber pair between the branching unit 114 and the terminal 102 (that is dedicated for communication between the terminals 101 and 102), and one optical fiber pair between the branching unit 114 and the terminal 103 (that is dedicated for communication between the terminals 101 and 103). Different numbers of optical fiber pairs may be portioned through each branch depending on current and anticipated demand for optical communication through the branches. The branching unit 114 may be any conventional branching unit, and may be a preexisting component already installed in a repeatered series of optical segments. The branching unit 114 may optionally also be installed at the time the unrepeatered optical segment is installed, and thus may be any branching unit, whether now existing or whether to be developed in the future.

In this example, the optical path distance between repeaters in the series 111 is labeled as D1, although the principles described herein are not limited to an embodiment in which the optical distance between repeaters is constant through the entire series of repeaters. However, the optical path distance of the unrepeatered optical segment 115 is labeled as D2. The optical path length D2 may be greater, perhaps much greater than the optical path length D1. As an example only, assume the average optical path distance for all of the repeatered optical segments is at least 30 kilometers, or perhaps at least 40 kilometers. In the example, perhaps the average optical path distance D1 is 50 kilometers. The unrepeatered optical path distance D2 may be perhaps 100 kilometers or greater, and perhaps at least 50 percent or even double the optical path distance D1. Through the use of Raman amplification (backwards and/or forwards) and/or remote optically pump amplifiers, the distance may be extended even further. For instance, 200 kilometers, 300 kilometers, or even longer distances may be achieved.

In the eastern direction, the unrepeatered optical segment 115 may optionally includes one or more Remote Optically Pumped Amplifiers (ROPA) 116B and 116D that potentially serve to optically amplify optical signals travelling in the eastern direction (i.e., eastern optical signals) from terminal 101 to terminal 103. The ROPA might be, for example, an Erbium-Doped Fiber (EDF) or other rare-earth doped fiber (e.g., in a spool or in the cable).

For instance, the ROPA 116B (if present) uses forward pump power from the branching unit 114 or repeater 113E to amplify the eastern optical signals. The branching unit 114 or repeater 113E may optionally provide the pump power in the form of forward Raman pumping, in which case the Raman pumping would be provided to the ROPA 116B in the same optical fibers as the eastern optical signals. The forward Raman pump power would dissipate as forward Raman amplification occurs in the fiber, but the residual forward Raman pump power would be used to pump the ROPA 116B. Alternatively or in addition, optically pump power may be delivered to the ROPA 116B through a separate fiber.

The ROPA 116D (if present) uses backwards pump power from the terminal 103 to amplify the eastern optical signals. The terminal 103 may optionally provide the pump power in the form of backwards, counter-propagating Raman pumping, in which case the Raman pumping would be provided to the ROPA 116D in the same optical fibers as the eastern optical signals. The backward Raman pump power would dissipate as backward Raman amplification occurs in the fiber, but the residual backward Raman pump power would be used to pump the ROPA 116D. Alternatively or in addition, optically pump power may be delivered to the ROPA 116D through a separate fiber.

In the western direction, the unrepeatered optical segment 115 may optionally includes one or more ROPAs 116C and 116A that potentially serve to optically amplify optical signals travelling in the western direction (i.e., western optical signals) from terminal 103 to terminal 101.

For instance, the ROPA 116C (if present) uses forward pump power from the terminal 103 to amplify the western optical signals. The terminal 103 may optionally provide the pump power in the form of forward Raman pumping, in which case the Raman pumping would be provided to the ROPA 116C in the same optical fibers as the western optical signals. The forward Raman pump power would dissipate as forward Raman amplification occurs in the fiber, but the residual forward Raman pump power would be used to pump the ROPA 116C. Alternatively or in addition, optically pump power may be delivered to the ROPA 116C through a separate fiber.

The ROPA 116A (if present) uses backwards pump power from the branching unit 114 or repeater 113E to amplify the western optical signals. The branching unit 114 or repeater 113E may optionally provide the pump power in the form of backwards, counter-propagating Raman pumping, in which case the Raman pumping would be provided to the ROPA 116A in the same optical fibers as the western optical signals. The backward Raman pump power would dissipate as backward Raman amplification occurs in the fiber, but the residual backward Raman as pump power would be used to pump the ROPA 116A. Alternatively or in addition, optically pump power may be delivered to the ROPA 116A through a separate fiber.

In one example, if Raman amplification is used, the Raman optical pump is on the order of 1480 nm in wavelength, while the optical signal itself is primarily in the C-band (1535 nm to 1575 nm) or L-band (1568 nm to 1608 nm). Of course, multiple wavelengths of Raman optical pumping may provide more uniform amplification across a wide band of optical signal.

FIG. 2 illustrates a power-distance profile 200 showing example optical powers as an optical signal propagates in the eastern direction (represented by arrow 201) from the terminal 101 to the terminal 103. As previously mentioned, the various ROPAs are each optional. In one embodiment, none of the ROPAs 116A through 116D are present. In other embodiments, any subset of one or more ROPAs 116A through 116D are present. In yet another embodiment, all of the ROPAs 116A through 116D are present. In addition, whether backwards or forwards Raman amplification are performed in either or both of the eastern or western optical signals is also optional. For instance, for eastern optical signals, perhaps no Raman amplification is performed. Alternatively, perhaps one of forward or backward Raman amplification is performed. Finally, perhaps both forward and backward Raman amplification is performed. The same alternatives for Raman amplification apply to western optical signals as well.

FIG. 2 illustrates a specific case in which there is only backward Raman amplification performed on eastern optical signals, and only forwards Raman amplification performed on western optical signals. In addition, there is only one ROPA 116D used on the eastern signals in this example, and no ROPAs used in the western signals. Those of ordinary skill in the art would understand that there would as be different profiles under different Raman amplification and ROPA usage.

The distances d0 through d8 of FIG. 2 correspond to the distances d0 through d8 of FIG. 1. Distance d0 occurs at the terminal 101. Proceeding in the eastern direction, distance d1 through d5 correspond to the positions of the repeaters 113A through 113E, respectively, through which the eastern optical signals would pass on their way from the terminal 101 to the terminal 103. Distance d6 corresponds to the ROPA 116A and 116B distance, although distance d6 has no significance in the example of FIG. 2 since ROPAs 116A and 116B are not present. Distance d7 corresponds to the ROPA 116C and 116D distance, although d7 only has significance in this example in the eastern direction since ROPA 116D is present, but ROPA 116C is not in this particular example. Finally distance d8 corresponds to the terminal 103 distance.

At distance d0, the eastern optical signal is still at the terminal 101, and is caused to be transmitted into the first optical segment 112A with some power. Provided that the repeater provides only discrete amplification, the first optical segment 112A has some logarithmic decay in power (which is expressed as linear decay in the vertically logarithmic diagram of FIG. 2). In FIG. 2, the horizontal axis 202 represents optical path distance. Accordingly, as the eastern optical signal moves through the optical segment 112A from d0 to d1, the optical signal linearly decays in which case there is no distributed amplification. However, the principles herein are not limited to repeaters that only perform discrete amplification, but apply to repeaters that perform distributed amplification as well. Each repeater is electrically powered and, for example, performs discrete amplification. As shown in FIG. 2, at distance d1, the repeater 113A performs discrete amplification restoring the average optical power level to about its original level.

FIG. 2 shows the process of linear attenuation followed by discrete amplification, which continues through the length of the repeatered series 111 until the optical signal is branched into the unrepeatered optical segment 115 using the branching unit 114. Continuing along, the optical power attenuates through the optical segment 112B as the optical signal proceeds from distance d1 to d2, and then is discretely amplified by the repeater 113B. The optical power once again attenuates through the optical segment 112C as the optical signal proceeds from distance d2 to d3, and then is discretely amplified by the repeater 113C. The optical power then again attenuates through the optical segment 112D as the optical signal proceeds from distance d3 to d4, and then is discretely amplified by the repeater 113D. The optical power then again attenuates through the optical segment 112E as the optical signal proceeds from distance d4 to d5, and then is discretely amplified by the repeater 113E.

Once the eastern optical signal departs the repeater 113E, the optical signal is routed by the branching unit 114 into the unrepeatered optical segment 115. During this process, the optical signal will undergo linear attenuation until the optical signal is discretely amplified at distance d7 by the ROPA 116D that is pumped by residual power from the backward Raman pump from the terminal 103I. In one embodiment, the optical fiber primarily composing the unrepeatered optical segment 115 is low loss fiber, possibly even less than 0.20 dB per kilometer. Such optical fibers are presently commercially available.

As the eastern optical signal proceeds from distance d7 to d8, the optical signal undergoes a combination of normal attenuation due to propagation through the optical fiber, as well as backward Raman amplification due to interactions with the counter-propagating backward Raman optical pump. At first, as the optical signal departs the ROPA 116D, the normal attenuation dominates resulting in a general linear decline in optical power. However, as the optical signal approaches distance d8, the power of the Raman optical light increases. Accordingly, the backward Raman amplification provides more and more gain as the eastern optical signal nears distance d8, eventually reaching the point where the Raman amplification dominates over normal optical fiber attenuation, and distributed gain is achieved. At distance d8, the eastern optical signal reaches the terminal 103, and may be discretely amplified, and subjected to other processing that the terminal 103 is capable of performing.

In one embodiment, the terminal 103 may be the NuWave XLS product (any one of versions 1 through 5 and possible future versions as well) which is a product of XTERA® Communications, Inc. However, other products may be used for the terminal 103 as well. For example, the Alcatel-Lucent 1620 Light Manager (LM), the Alcatel-Lucent 1621 Link Extender, the Alcatel-Lucent 1626 Light Manager, the NEC Submarine Systems T320 Line terminal Equipment, the NEC Submarine Systems SLR320 Line terminal Equipment for Repeaterless Systems, the Fujitsu Flashwave S650 SLTE, the Huawei Submarine Networks Optix BWS 1600S LTE, and other commercially available terminals will also suffice. The third terminal 103 may also perform forward Raman pumping in the western direction to thereby amplify western optical signals travelling from the terminal 103 to the terminal 101 via the use of a co-propagating Raman pump.

FIG. 3 illustrates a power-distance profile showing example optical powers as an optical signal propagates in the western direction (represented by arrow 301) from the terminal 103 to the terminal 101. The distances d0 through d8 of FIG. 3 correspond to the distances d0 through d8, respectively, of FIGS. 1 and 2.

Initially, as the optical signal departs the terminal 103 and travels in the as western direction through the unrepeatered optical segment 115, the optical signal will have an initial amplification boost due to forward Raman amplification. However, as the forward Raman pump power attenuates, the normal attenuation of the fiber gradually becomes dominant. In the embodiment of FIG. 3, there is not a ROPA for amplification of western optical signals. Accordingly, the western optical signal power may attenuate to levels that are quite low as the optical signal approaches distance d5.

At distance d5, the repeater 113E discretely amplifies the optical signal. If the repeater 113E is sufficiently able, the repeater 113E might amplify the optical signal fully so that the power profile reaches the level of the dashed lines 302. However, since the repeater 113E may be an existing repeater that may not have been designed for such high levels of amplification, the repeater 113E might just perform a higher-level of amplification than it might normally do, but yet not quite enough to restore the optical signal to the levels designated by the dashed lines 302.

The optical signal undergoes further attenuation from distance d5 to d4, and is then further discretely amplified using repeater 113D at distance d4. Once again, since the optical power level was so low prior to the optical signal reaching distance d5, it may take several repeater segments before the optical power reaches its optimum operating level. In the illustrated example, the optical power after discrete amplification at distance d4 still has not achieved the optimum level represented by the dashed lines 302.

The western optical signal then travels from distance d4 to d3, and is then discretely amplified by repeater 113C at distance d3. The signal then travels from distance d3 to d2, and is discretely amplified by repeater 113B at distance d2. The optical signal is now at its optimum optical power level. In one embodiment, the repeater amplification levels may be specifically tailored such that the western optical signal is at its optimum power level prior to being received by the terminal. The western optical signal travels from distance d2 to d1, and then is discretely amplified by repeater 113A at distance d1. The optical signal then completes its final segment travelling from distance d1 to d0, where the signal may be received by the terminal, and subjected to further processing by the terminal 101.

Having described the embodiment of FIG. 1 in some detail, various alternatives will now be described. In one embodiment, the branching unit 114 or perhaps the repeater 113E may perform forward Raman pumping in the eastern direction into the unrepeatered optical segment 115. That would allow the optical path distance D2 of the unrepeatered optical segment to be further extended, possibly reaching distances of over 500 kilometers. In this case in particular, it may be advantageous to have another ROPA 116B to perform remote amplification in the eastern direction.

Alternatively or in addition, the branching unit 114 or the repeater 113E may be configured to perform backward Raman pumping into the unrepeatered optical segment 115 to thereby perform amplification of the western optical signal traveling from the terminal 103 to the terminal 101. In this case in particular, it may be advantageous to have a another ROPA 116A to perform remote amplification in the western direction.

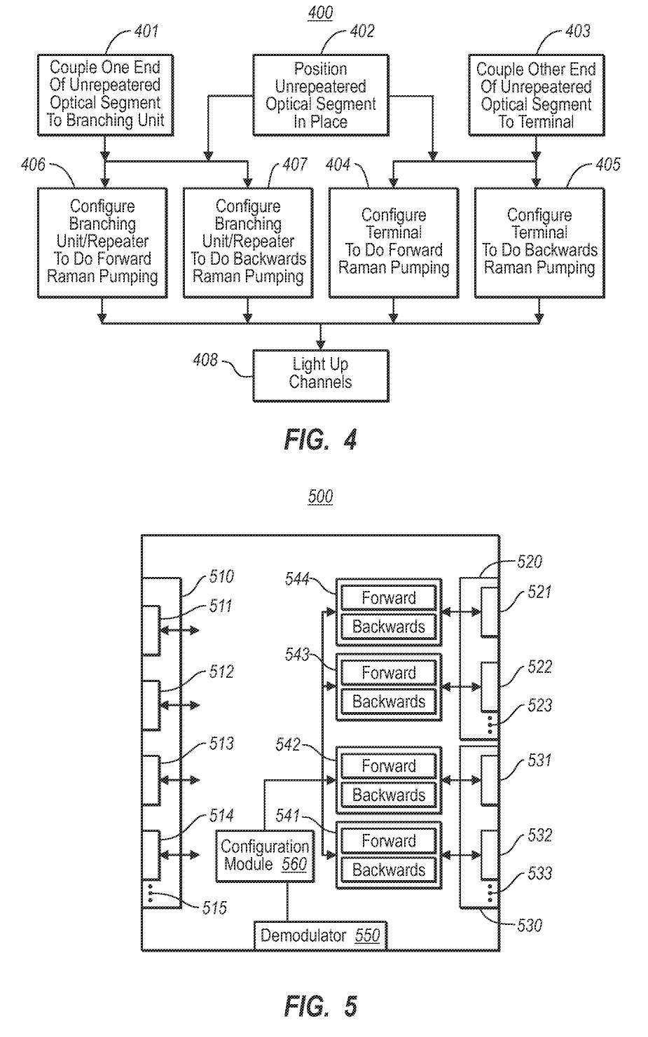

FIG. 4 illustrates a flowchart of a method 400 for installing the unrepeatered optical segment into the optical communications network. The method 400 will be described with frequent reference to the optical communications network 100 of FIG. 1. The method 400 includes optically coupling one end of the unrepeatered optical segment to the branching unit (act 401), positioning the unrepeatered optical segment at its approximate position where it will sit during operation (act 402), and optically coupling the other end of the unrepeatered optical segment to the remote terminal (act 403). These acts are illustrated at approximately the same vertical level in FIG. 4 in order to emphasize that it is not important the exact order in which these acts occur. Some or all of the acts may even occur concurrently.

Referring to act 401, one end of the unrepeatered optical segment is optically coupled to the branching unit. In one embodiment, the unrepeatered optical segment is provided in a cable that does not have an electrical power conductor. However, the cable provided in the repeatered series of optical connections does have an electronic power conductor in order to provide electrical power to the various repeaters. The powered cable of the repeatered series may be optically coupled to the unpowered cable of the unrepeatered optical segment by splicing all of the optical fibers of the unpowered cable to appropriate corresponding optical fibers of the powered cable. Also, the electrical power conductor of the powered cable would be terminated. If the branching unit were a submarine branching unit, the branching unit might be brought to the surface to perform the optical coupling. Referring to FIG. 1, the unrepeatered optical segment 115 may be optically coupled to the branching unit 114. Some examples in this application have been described using a submarine branching unit. It is understand that the principles described herein can be applied to a terrestrial branching unit, an extension for a terminal landing site, or any other branch(es) or extension(s) from a repeatered system.

Referring to act 402, the unrepeatered optical segment may be positioned at one end at the approximate position that the last repeater would sit during operation as of the unrepeatered optical segment and at the terminal at the other end. For instance, if the unrepeatered optical segment were to lie on an ocean or sea floor, the unrepeatered optical segment may be rolled out from a ship onto the ocean floor such that the unrepeatered optical segment spans the appropriate length. In a terrestrial application, the unrepeatered optical segment may similarly be situated in place using other mechanisms for placement. Referring to FIG. 1, the unrepeatered optical segment 115 may be positioned along the length D2.

Referring to act 403, the unrepeatered optical segment is then optically coupled to the terminal. Mechanisms for optically coupling an unrepeatered optical segment to a terminal are known in the art, and thus will not be described in detail here. Referring to FIG. 1, the unrepeatered optical segment 115 may be optically coupled to the terminal 103.

Referring to FIG. 4, the terminal is then configured to perform forward Raman pumping (act 404) and/or backward Raman pumping (act 405). In the case of FIGS. 2 and 3, the terminal 103 performs backward Raman pumping as counter-propagating optical power against the eastern optical signal travelling towards the terminal 103. The terminal 103 performs forward Raman pumping as co-propagating optical power travelling with the western optical signal travelling away from the terminal 103. Terminals that may be configured to forward and backward Raman pump are known in the art and are commercially available, as previously discussed.

The method 400 also includes the optional configuring of the branching unit or the final repeater to perform forward Raman pumping co-propagating with the eastern optical signal (act 406) and/or backward Raman pumping to thereby perform backward Raman amplification counter-propagating against and amplifying the western optical signals (act 407). Referring to FIG. 1, the branching unit 114 or the as repeater 113E may be configured to perform such Raman pumping into the unrepeatered optical segment 115. This might further extend the reach of the unrepeatered optical segment 115, but would increase the electrical power used by the branching unit 114 or repeater 113E. Such power might be supplied through the electrical power line of the repeatered series 111, and/or perhaps through an electrical power line of the cable providing the unrepeatered optical segment 115. Once the channel is configured (via acts 404 through 407), the channel may be lit up (act 408), thereby becoming prepared for optical communication.

In one embodiment, the branching unit 114 or the repeater 113E may be a configurable device that responds to externally applied control signals to thereby control whether or not forward and/or backward Raman amplification is to be performed, and for which optical fiber(s) Raman amplification is to be performed. FIG. 5 schematically illustrates a configurable Raman device 500 that may respond in that manner to such an externally applied control signal. The device 500 may be, as previously mentioned, the branching unit 114 or the repeater 113E of FIG. 1, although the device 500 may be used in any application in which external configuration of Raman amplification may be advantageous.

The device 500 includes number of optical ports. In the illustrated embodiment, there are eight optical ports illustrated 511, 512, 513, 514, 521, 522, 531 and 532. However, the ellipses 515, 523, and 533 represent that there may be other numbers of optical ports—more or even fewer. Each optical port may (but need not) serve a pair of optical fibers for bidirectional communication.

If the device 500 is a repeater, the optical ports 510 (including ports 511, 512, 513 and 514) may serve to optically communicate over one optical segment to the neighboring repeater or terminal, and the optical ports 520 (including ports 521 and 522) and the optical ports 530 (including ports 531 and 532) may serve to optically communicate over the other optical segment to the other neighboring repeater or terminal.

If the device 500 is a branching unit, the optical ports 510 might be principal optical ports, the ports 520 might be a first subset of branched optical ports (perhaps leading to location B), and the ports 530 might be a second subset of branched optical ports (perhaps leading to location C). In that case, perhaps bidirectional fibers extend between optical ports 511 and 521, between optical ports 512 and 522, between optical powers 513 and 531 and between optical ports 514 and 532. The ellipses 523 represents that there may be more or less than two optical ports in the optical port subset 520. Likewise, ellipses 533 represents that there may be more or less than two optical ports in the optical port subset 530.

The demodulator 550 receives an externally applied control signal. The control signal may be applied to one of the optical channels received into one of the optical ports 510, 520 and/or 530. However, the externally applied control signal may also be a control signal modulated on the supplied electrical power conductor. As an alternatively, the demodulator 550 may interpret a sonar or other sound signal as a control signal, which might help in a submarine environment if an external control signal cannot otherwise be sent to the device 500.

The demodulated control signal is provided to the configuration module 560, which responds to the control signal by turning off or on the appropriate forward Raman amplification module, or backward Raman amplification module for any of the Raman modules 541, 542, 543 and 544. Each Raman module 541 through 544 may serve a distinct optical fiber pair, and may also be separately controllable.

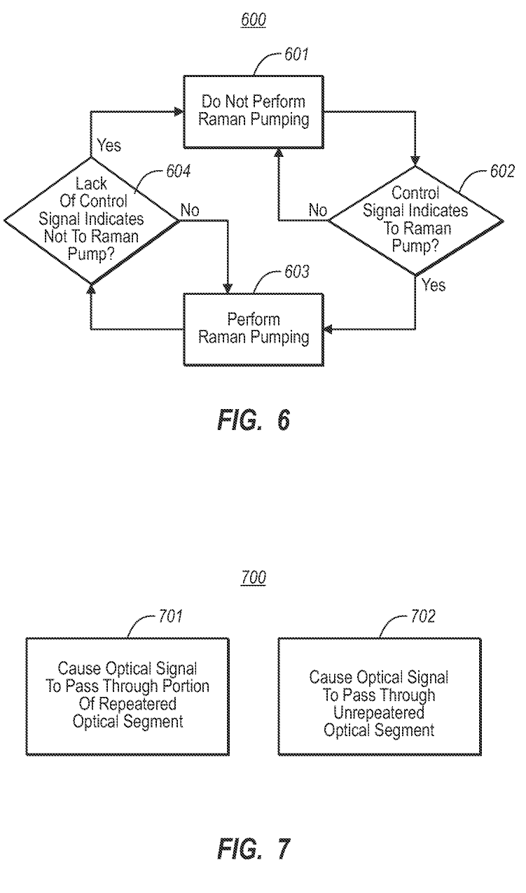

FIG. 6 illustrates a flowchart of a method 600 for configuring the optical as communication network such that the device 500 performs or does not perform Raman amplification. An instance of the method 600 may be independently performed for perhaps each optical fiber pair, or for each direction (forward and/or backward) of Raman amplification in each pair.

The method 600 begins in either the state in which Raman pumping is not being performed (act 601), or in the state in which Raman pumping is being performed (act 603). For purposes of discussion, assume that we are in the state in which the Raman pumping is not performed for a particular optical pair and direction (act 601). In that state, so long as there is not a control signal applied that indicates that Raman pumping should begin (No in decision block 602) and/or if there is a control signal that indicates that Raman pumping should still not be performed (also No in decision block 602), then the device continues to not perform the corresponding Raman pumping (act 601). If, on the other hand, a control signal is applied that indicates that Raman pumping should be begin (Yes in decision block 602) and/or if there is a lack of a control signal that is needed to keep Raman pumping from beginning (also Yes in decision block 602), then Raman pumping begins (act 603). The Raman pumping continues so long as there is not a control signal indicating that Raman pumping should cease (No in decision block 604) and/or if there is a control signal that indicates that Raman pumping should continue (also No in decision block 604). If, at some point, a control signal is received that indicates that Raman pumping should cease (Yes in decision block 604) and/or if there is a lack of a control signal need to prevent Raman pumping from stopping (also Yes in decision block 604), then Raman pumping ceases (act 601).

In one embodiment, other criteria may be used for the device to determine as whether or not to start or stop Raman pumping. One criterion may be a measured receive signal power over the corresponding length of optical fiber. If the received signal power is too low, then the device may initiate Raman pumping on its own accord.

FIG. 7 illustrates a flowchart of a method 700 for optically communicating between the terminals 101 and 103 of FIG. 1. The method 700 includes two acts 701 and 702. The order that the acts are performed in will depend on whether the optical signal is an eastern optical signal or a western optical signal.

In the case of an eastern optical signal, an optical signal is caused to pass through the repeatered optical segment between the first terminal 101 and the branching unit 114 (act 701), and then the optical signal is caused to pass through the unrepeatered optical segment to the other terminal 103 (act 702). In the case of a western optical signal, an optical signal is caused to pass from the terminal 103 through the unrepeatered optical segment to the branching unit 114 (act 702), and then the optical signal is caused to pass through the repeatered optical segment between the branching unit 114 and the terminal 101 (act 701).

Accordingly, the principles described herein offer an improved mechanism for extending optical communication by branching an unrepeatered optical segment into an existing repeatered series of optical segments. Since the unrepeatered optical segment may be longer, perhaps much longer, than the average distance between repeaters in the existing system, the cost of providing optical communication to remote locations can be reduced. While the bandwidth of such an unrepeatered optical segment may not be the same as a repeatered system (all other things being equal), the unrepeatered optical segment might satisfy the optical communication as needs of location C and at a lower cost, thereby providing an important and advantageous alternative to branching using strictly repeater systems.

Accordingly, the principles described herein may permit for more remote areas to have access to information communicated optically, thereby providing a significant advancement to the state of the art, and potentially to the quality of life in remote areas.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical communications network comprising:
an unrepeatered optical segment optically coupling a branching unit to a remote terminal, the branching unit optically coupled within a series connection of a plurality of repeatered optical segments, the series connection optically interconnecting a first terminal to a second terminal, each repeatered optical segment having a repeater at a first end and either a repeater or one of the first or second terminals at a second end, the remote terminal being a third terminal.

2. The optical communications network of claim 1, further comprising:
the remote terminal.

3. The optical communications network of claim 2, further comprising:
the branching unit.

4. The optical communications network of claim 3, further comprising:
the series connection of the plurality of optical segments.

5. The optical communications network of claim 1, wherein an average optical path distance for all of the plurality of repeatered optical segments is at least 30 kilometers.

6. The optical communications network of claim 5, wherein an optical path distance for the unrepeatered optical segment is at least 100 kilometers, and is at least 50 percent more that the average optical path distance for all of the plurality of repeatered optic segments.

7. The optical communications network of claim 1, wherein an average optical path distance for all of the plurality of repeatered optical segments is at least 40 kilometers.

8. The optical communications network of claim 1, wherein the third terminal performs backward Raman pumping for amplification of eastern optical signals travelling from the first terminal to the third terminal.

9. The optical communications network of claim 8, wherein the unrepeatered optical segment includes a first ROPA that uses the backward Raman pumping to amplify the eastern optical signals.

10. The optical communications network of claim 8, wherein the branching unit or a repeater between the branching unit and the first terminal performs forward Raman pumping for amplification of eastern optical signals travelling from the first terminal to the third terminal.

11. The optical communications network of claim 10, wherein the unrepeatered optical segment includes a first ROPA that uses the forward Raman pumping to amplify the eastern optical signals.

12. The optical communications network of claim 11, wherein the unrepeatered optical segment includes a second ROPA that uses the backward Raman pumping to amplify the eastern optical signals.

13. The optical communications network of claim 10, wherein the unrepeatered optical segment includes a first ROPA that uses the backward Raman pumping to amplify the eastern optical signals.

14. The optical communications network of claim 1, wherein the branching unit or a repeater between the branching unit and the first terminal performs forward Raman pumping for amplification of eastern optical signals travelling from the first terminal to the third terminal.

15. The optical communications network of claim 14, wherein the unrepeatered optical segment includes a first ROPA that uses the forward Raman pumping to amplify the eastern optical signals.

16. The optical communications network of claim 1, wherein the third terminal performs forward Raman pumping for amplification of western optical as signals travelling from the third terminal to the first terminal.

17. The optical communications network of claim 16, wherein the unrepeatered optical segment includes a first ROPA that uses the forward Raman pumping to amplify the western optical signals.

18. The optical communications network of claim 16, wherein the branching unit or a repeater between the branching unit and the first terminal performs backward Raman pumping for amplification of western optical signals travelling from the third terminal to the first terminal.

19. The optical communications network of claim 18, wherein the unrepeatered optical segment includes a first ROPA that uses the forward Raman pumping to amplify the western optical signals.

20. The optical communications network of claim 19, wherein the unrepeatered optical segment includes a second ROPA that uses the backward Raman pumping to amplify the western optical signals.

21. The optical communications network of claim 18, wherein the unrepeatered optical segment includes a first ROPA that uses the backward Raman pumping to amplify the western optical signals.

22. The optical communications network of claim 1, wherein the branching unit or a repeater between the branching unit and the first terminal performs backward as Raman pumping for amplification of western optical signals travelling from the third terminal to the first terminal.

23. The optical communications network of claim 22, wherein the unrepeatered optical segment includes a first ROPA that uses the backward Raman pumping to amplify the western optical signals.

24. The optical communications network of claim 1, wherein the unrepeatered optical segment includes a first remote optical pumped amplifier for amplification of optical signals traveling in a first set of one or more optical fibers and in a first direction from the branching unit to the third terminal.

25. The optical communications network of claim 24, wherein the third terminal performs backward Raman pumping into the first set of one or more optical fibers.

26. The optical communications network of claim 25, wherein the branching unit or a repeater between the branching unit and the first terminal performs forward Raman pumping into the first set of one or more fibers of the unrepeatered optical segment.

27. The optical communications network of claim 24, wherein the unrepeatered optical segment includes a second remote optical pumped amplifier for as amplification of optical signals traveling in a second set of one or more optical fibers and in a second direction from the third terminal to the branching unit.

28. The optical communications network of claim 27, wherein the third terminal performs forward Raman pumping into the second set of one or more optical fibers.

29. The optical communications network of claim 28, wherein the branching unit or a repeater between the branching unit and the first terminal performs backward Raman pumping into the second set of one or more fibers of the unrepeatered optical segment.

30. The optical communications network of claim 1, wherein the branching unit or a repeater between the branching unit and the first terminal is configurable to perform forward Raman pumping into a first set of one or more fibers of the unrepeatered optical segment in which optical signals travel from the branching unit to the third terminal, and in which the forward Raman pumping occurs using pump optics resulting from the forward Raman pumping.

31. The optical communications network of claim 1, further comprising:
the third terminal, wherein the third terminal performs backward Raman pumping into a first set of one or more fibers of the unrepeatered optical segment in which optical signals travel from the branching unit to the third terminal.

32. The optical communications network of claim 31, wherein the unrepeatered optical segment includes a remote optical pumped amplifier that performs optical amplification using the backward Raman pumping from the third terminal.

33. The optical communications network of claim 1, wherein the unrepeatered optical segment is primarily composed of optical fiber have an attenuation of 0.20 dB per kilometer or less.

34. The optical communications network of claim 1, further comprising:
the branching unit.

35. A method for optically communicating between a first terminal to a third terminal in an optical communications network that includes a series connection of a plurality of repeatered optical segments coupled between the first terminal and a second terminal, a branching unit optically coupled within the series connection of repeatered optical segments, and an unrepeatered optical segment optically coupling the branching unit to the third terminal, the method comprising:
an act of causing an optical signal to pass through the unrepeatered optical segment between the branching unit and the third terminal; and
an act of causing the optical signal to pass through a portion of the plurality of repeatered optical segments between the first terminal and the branching unit.

36. The method in accordance with claim 35, further comprising the following prior to the act of causing the optical signal to pass through the unrepeatered optical segment:
an act of selectively configuring the branching unit to perform forward Raman pumping.

37. The method in accordance with claim 36, wherein the act of selectively configuring is performed using an optical control signal.

38. The method in accordance with claim 35, further comprising the following prior to the act of causing the optical signal to pass through the unrepeatered optical segment:
an act of selectively configuring a repeater between the first terminal and the branching unit to forward Raman pump into the unrepeatered optical segment.

39. The method in accordance with claim 35, wherein the optical signal is caused to pass from the first terminal to the third terminal, such that the act of causing the optical signal to pass through the portion of the plurality of repeatered optical segments between the first terminal and the branching unit occurs before the act of causing the optical signal to pass through the unrepeatered optical segment between the branching unit and the third terminal.

40. The method in accordance with claim 35, wherein the optical signal is caused to pass from the third terminal to the first terminal, such that the act of causing the optical signal to pass through the portion of the plurality of repeatered optical segments between the first terminal and the branching unit occurs after the act of causing the optical signal to pass through the unrepeatered optical segment between the branching unit and the third terminal.

41. The method in accordance with claim 40, wherein the optical signal is at least primarily is in the C-band or L-band.

42. A method for configuring an optical communication network that includes a series connection of a plurality of repeatered optical segments coupled between the first terminal and a second terminal, a branching unit optically coupled within the series connection of repeatered optical segments, and an unrepeatered optical segment optically coupling the branching unit to the third terminal, the method comprising:
after the branching unit is installed to be optical coupled within the series connection of repeatered optical segments, an act of signaling the branching unit to perform forward Raman amplification into the unrepeatered optical segment, wherein the branching unit performs forward Raman amplification after the act of signaling, but not before the act of signaling.

43. A method for configuring in accordance with claim 42, wherein the act of signaling occurs using an optical signal transmitted through at least a portion of the plurality of repeatered optical segments.

44. A method in accordance with claim 42, further comprising the following after the act of signaling the branching unit post-installation to perform forward Raman amplification:
an act of signaling the branching unit to no longer perform forward Raman as amplification, wherein the branching unit no longer performs forward Raman amplification after being signaled to no longer perform forward Raman amplification.

45. A method for installing an unrepeatered optical segment between a branching unit and a remote terminal, the branching unit optically coupled within a series connection of a plurality of repeatered optical segments, the series connection optically interconnecting a first terminal to a second terminal, each repeatered optical segment having a repeater at a first end and either a repeater or one of the first or second terminals at a second end, the remote terminal being a third terminal, the method comprising:
an act of optically coupling one end of the unrepeatered optical segment to the branching unit; and
an act of position the unrepeatered optical segment at its approximate position where it will sit during operation of the unrepeatered optical segment.

46. A method of claim 45, further comprising:
an act of optically coupling the other end of the unrepeatered optical segment to the third terminal.

47. A method of claim 46, further comprising:
an act of configuring the third terminal to perform backward Raman pumping into the unrepeatered optical segment.

48. A method of claim 46, wherein the unrepeatered optical segment is provided in a cable that does not have an electronic power connection.

49. A method of claim 46, further comprising:
an act of configuring the third terminal to perform forward Raman pumping into the unrepeatered optical segment.

50. A method of claim 45, wherein an optical path distance of the unrepeatered optical segment is at least 50 percent greater than an average optical path distance of all of the optical path distances of the plurality of repeatered optical segments.

51. A branching unit comprising:
a plurality of optical ports, each configured to receive a fiber optic pair, the plurality of optical ports including a subset of one or more principal optical ports, a first subset of one or more branched optical ports, and a second subset of one or more branched ports, wherein the branching unit is configured to branch optical signals from and to the first and second subset of branched optical ports to and from, respectively, the subset of one or more principal optical ports; and
a configurable Raman pump unit configured to selectively perform Raman pumping through one or more of the first and second subsets of the branched optical ports.

52. The branching unit of claim 51, wherein the configurable Raman pump unit is selected to perform Raman pumping or not to perform Raman pumping through an externally applied control signal.

53. The branching unit of claim 52, wherein the applied control signal is an optical control signal applied through one or the plurality of optical ports.

53. The branching unit of claim 51 wherein the configurable Raman pump unit is configurable to perform Raman pumping on the first subset of one or more as branching optical ports, without necessarily performing Raman pumping on the second subset of one or more branching optical ports.
